(19) United States
(12) Patent Application Publication
(10) Pub. No.: US 2004/0153990 A1
(43) Pub. Date: Aug. 5, 2004

(54) Component self-description package method and operation method

(76) Inventors: Rong Chen, Shanghai (CN); Yipeng Su, Shanghai (CN); Yongwen Du, Shanghai (CN); Yuzhou Liang, Shanghai (CN); Zhongqiang Ye, Shanghai (CN)

Correspondence Address: RABIN & BERDO, P.C., Suite 500, 1101 14th Street, N.W., Washington, DC, 20005, US

(21) Appl. No.: 10/747,232

(22) Filed: Dec. 30, 2003

(30) Foreign Application Priority Data
Dec. 31, 2002 (CN) 02160137.2

(51) Int. Cl. G06F 9/44

(52) U.S. Cl. 717/100

(57) ABSTRACT

A component self-description package method, in which, the class information and lead-in information of description component are packaged into component, the class information and lead-in information are from pre-compile file. The class information includes the interface and method list describing the component lead-out, the lead-in information includes information of uniform resource name and edition number etc of other component, which the component relies on. In present invention, the self-description ability of standard component object model is extended, especially after introducing the lead-in information, the non-register operation, dynamic upgrade and self-rolling operation of component are realized.

### FIELD OF THE INVENTION

The present invention relates to a component package and operation method, especially relates to a package method of realizing component self-description and self-explanation, and a operation method of the component self rolling and dynamic upgrade. The present invention belongs to the computer technology field.

### BACKGROUND OF THE INVENTION

The component-wise technology—COM (component object model) was raised by the Microsoft Co, the COM technology emphasizes the self-description of component, and emphasizes the self-description of interface data type, in order to separate the interface from the realization in binary stage, and reach the target of over-address space interface (or remotely). The self-description of component and interface data is one of theory basis and foothold of COM.

In view of the current designation and realization, however, the existing component technology MSCOM hasn't carry out this thought completely. The main aspects are as follows:

1. In MSCOM, some relative operation information of component are totally stored in the general database of system-register table, the component must register before it could operation correctly. But the relative operation information of component itself should be one of content of component self-description.

2. In MSCOM, one of the description method to component lead-out interface is utilizing the type library metadata (metadata, for describing the data of component information), the type library itself is packeted with the DLL (dynamic link library) of component. However the type library information is not explained by component itself, but is abstracted and explained by system program OLE32.DLL, and this doesn't meet the self-description thought of component also.

3. In most cases, a component may utilize some functions of other component, i.e. a co-dependent relation exists between components. In MSCOM, the component has only the self-description about oneself interface (or function), but lack the self-description to the component dependent relation. So the rolling operation and dynamic upgrade of component are not possible, but in today's network computing epoch, the correct component dependent relation is the basis of rolling operation and dynamic upgrade of component.

On one side, the TypeLib of COM component describes the lead-out information of interface and method etc supported by component itself, and component client could fetch these interface methods. On other side, a component operation usually depends on other component, i.e. the component program itself may be the client of other component program.

In MSCOM, the component program has no description of lead-in information about itself, the component dependent relation is based on the general register table, but the increasing and modifying of register table information are accomplished through the installation program of component. The drawbacks of this method are as below:

1. All the component operations are dependent on the register table, the system must be installed completely before operation, and the system register table would become large and difficulty to maintain after repeated installing and downloading of more software.

2. Owing to the fact that register table is a general database, so the access jurisdiction is difficulty to control, and the register table likely to become an invaded point from virus and intruder software. Take a simple example: suppose the corresponding rout of a component class Csample in register table is C:\Sample\sample.dll, after obtaining the modifying jurisdiction by intruder software, it may modify this rout, make it pointing to a program oneself, then in time of Csample component program utilizing the component class Csample, it would utilize the program specified by the intruder software, rather than the sample.dll component.

3. The dependent relation between components is based on the complete installation basis, e.g. suppose A component relies on B, if B doesn't be installed in system, the A component wouldn't operate correctly because there is no any information about B component in system.

### BRIEF DESCRIPTION OF THE INVENTON

The purpose of present invention is providing a component self-description package method and operation method, in which, the lead-out information describing the interface and method supported by component itself is packaged in component, making the component has ability of self-description and self explanation, the interface is separated from the realization, thus realizing a over-address and remotely component interface.

Another purpose of present invention is providing a component self-description package method and operation method, in which, the component lead-in information is packaged, the dynamic upgrade and self rolling operation are realized, so the local storage resource is saved to a large extent, it don't need to install completely more software before system operation and easy for maintenance.

Another purpose of present invention is providing a component self-description package method and operation method, in which, it has even better operation safety and flexibility, and the dependent to local resource from system is largely reduced.

The present invention is realized by the following technologies: A component self-description package method, the class information and lead-in information of description component is packaged into component, the class information and lead-in information are from pre-compile file, in which, the class information includes the interface and method list describing the component lead-out, and the class information is packeted as a resource data into the resource section of component file, the lead-in information includes the uniform resource name, edition number and renew period etc of other component used by the component.

The component source program generated automatically according to class information includes the realization code of standard lead-out function of component class object fetching, in the realization code, other than realizing the semanteme of standard component class object fetching, also supports to utilize a system pre-defining special class identification to obtain the class information of component.

When system or component client needs to utilize the class information, the system pre-defining special class identification is used as a input parameter, and the class object fetching function of component is invoked for fetching the class information.

Package the lead-in information description into component, the information is for describing the component dependent relation to other component. The lead-in information description includes component's uniform resource name, edition number, class information edition number, revised date and renew period, it is utilized in component upgrade or fault recovery. The component lead-in information is generated by lead-in information pre-handler.

Further, the operation steps of pre-handler are as bellow:

Step 1: read in compile source program first;

Step 2: fetch a statement to make syntax analysis and judge if is a lead-in, if yes, upload the component file specified by the statement, if no, go to Step 3;

Step 3: write the current statement in the temporary source program and return back to Step 2;

Step 4: upload the class information of component file, go to step 5 if succeed, otherwise go to Step 3;

Step 5: fetch the component's uniform resource name and edition, last revised date and renew period information from class information of component resource section, and add them to the lead-in information of current program;

Step 6: generate the head file relative to the component definition according to the class information of lead-in component, modify the lead-in statement into a head file including—statement and write in the temporary source program.

Step 7: write the lead-in information of current program in the lead-in information file.

Repeat execute the steps above until the syntax analysis to source program is ended, in this way, the pre-handler generates a head file about the lead-in component definition for each lead-in statement of source program.

The head file of component generated by pre-handler includes the class identification announcement of component, the class identification consists of the global unique identifier (GUID) and uniform resource name (URN), the uniform resource name of lead-in component is announced as a part of class identification together with class identification.

The lead-in information file generated by the lead-in information pre-handler includes the complete description of component lead-in information, including the information of other used component's uniform resource name, last revised date and renew period etc, and they are packeted in the resource section of component file.

A operation method of self-description package component fulfilled on basis of claims above, in which, the component client utilizes the specified component class identification in operation, the system finds out the component file according to the uniform resource name in class identification automatically and makes the uploading. After component file is installed, system finds out the relative component class according to the global unique identifier in class identification.

Concretely, the steps of uploading the component by system according to uniform resource name are as below:

Step 1: the component client creates component object through specifying the class identification;

Step 2: system abstract the uniform resource name of component from the class identification;

Step 3: examine with the uniform resource name that if component program existed, and go to Step 5 if existed, otherwise go to step 4;

Step 4: abstract the lead-in information other than uniform resource name from component client resource section, download automatically the component program from network according to uniform resource name, edition number, renew period information; go to step 5 if succeed, otherwise return back to step 3, or in failure, give up the automatic download of component program according to the set condition till end.

Step 5: upload the component program and create the component object according to the global unique identifier in class identification.

A chain dependent relation between components is established by the uniform resource name in class identification, when a component utilizes another component through class identification, the system upload another component according to the uniform resource name in class identification and a self rolling operation is realized.

When component is uploaded for first time after system starting, the system would fetch the class information of component from resource section of component, and judge if the component needs to upgrade according to the component renew period in class information, in case of renew period begins, the system would download automatically the component renew edition from network according to the uniform resource name of component, and realize the dynamic upgrade.

It may be seen from the technical analysis above, in present invention, the class information is acting as a component description metadata, the role of class information is similar to the type library of component (MSCOM) in current technology, the class information is compiled from component definition source file, and is a binary form of the file. The difference with MSCOM is that the MSCOM utilizes the special program of system program to fetch and explain the type library information.

In present invention, the class information may be fetched from component with a special class identification, the explanation of component metadata don't depend on other DLL file.

Moreover, in component package of present invention, apart from the class information of component itself is packaged in the component, the dependent relation is also be packaged. I.e. a dependent relation from a component to other component is also be packaged in component as the component metadata, this metadata is called the lead-in information of component.

By the package of class information and lead-in information in present invention component, the non-register operation of component may be realized. It could also support the dynamic upgrade and self-rolling operation of component.

### BRIEF DESCRIPTION OF THE APPENDED DRAWINGS

FIG. 1 is an illustrative view showing the generation of component lead-in information in present invention;

FIG. 2 is a flow view showing the URN load component in present invention.

### DETAILED DESCRIPTION OF THE INVENTION

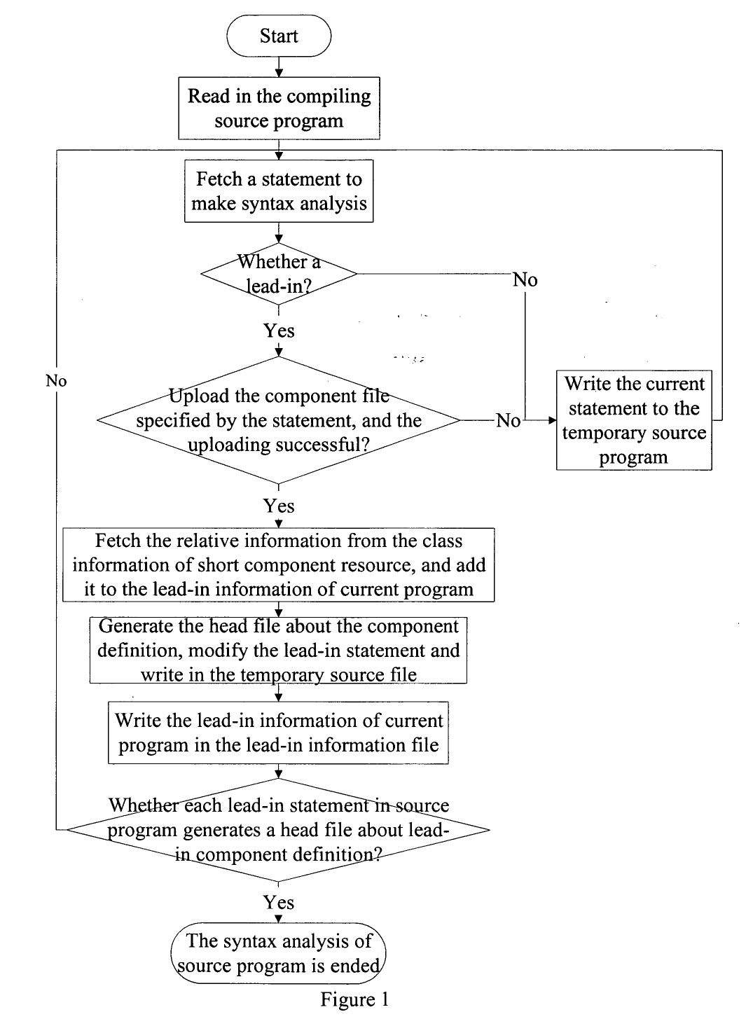

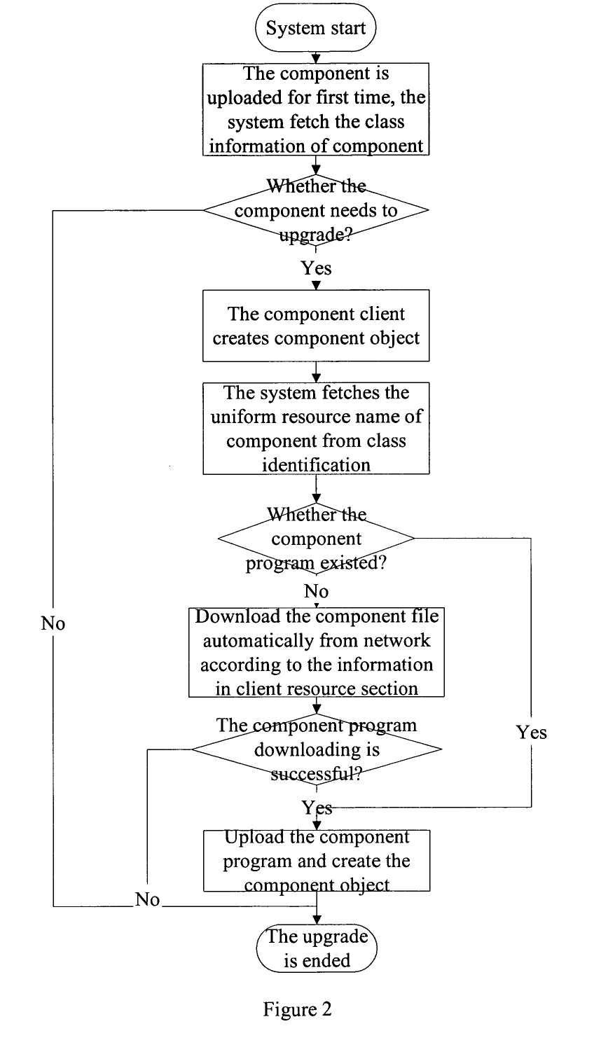

Refer to FIGS. 1, 2, the measures below are taken in present invention for improving and extending to current technology MSCOM in the self-description package and operation:

In present invention, the class information is acting as a component description metadata, the role of class information is similar to the type library of MSCOM, the class information is compiled from CDL (Component Definition Language) file, and is a binary form of the CDL file. The difference with MSCOM is that the MSCOM utilizes the system program OLE32.DLL to fetch and explain the type library information; in present invention, the metadata information may be fetched from component by a special class identification, and the explanation of component metadata doesn't rely on the other DLL file.

In component package of present invention, apart from the class information of component itself is packaged in the component, the dependent relation is also be packaged. I.e. a dependent relation from a component to other component is also be packaged in component as the component metadata, this metadata is called the lead-in information of component.

By the package of class information and lead-in information in present invention component, the non-register operation of component may be realized. It could also support the dynamic upgrade and self-rolling operation of component.

Concretely, the generation of component class information in present invention is a compiling result of component definition file, the class information is utilized as a metadata information of component program, and is for describing the interface and method list of component lead-out. The class information is also a basis of generating automatically the component source program. In component program compiling, the class information is packeted as a resource data into the resource section of component DLL file.

The fetching way of component class information in present invention is: the component source program generated automatically according to class information includes the realizing code of fetching the class object by standard component lead-out function, the class object fetching function completes a standard COM semanteme: the component class object fetching is utilized for creating the object of component object. In the automatic realization of class object, it supports to obtain the metadata of component by a special class identification pre-defined by system, other than the class object.

Concretely:

In case of the class identification specified by the input parameter is a special class identification pre-defined by system, the class object fetching function returns the start address of component class information;

When system or component client needs to utilize the class information metadata, the above special class identification is used as a input parameter, and the class object fetching function of component is invoked for fetching.

The steps of component metadata obtaining are as below:

When obtaining the component metadata, upload the component module, then obtain the start address of component class object fetching function, and fetch the component class object fetching function to fetch the component class information.

When system or component client needs to utilize the class information metadata, the above special class identification is used as an input parameter, and the class object fetching function is invoked for fetching.

It may be seen from above, the obtaining of component class information doesn't need other system program's participation, it only need to fetch the class object fetching function of component DLL model.

For generating the component lead-in information, the component must specify its uniform resource name (URN, Uniform Resource Name), URN is a characteristic string, this characteristic string is similar to uniform resource name URL (Uniform Resource Locator), and is a network location information about component file. The definition example of URN in present invention component is as below:

Version(1,0),uuid(e363b985-8a3a-40a6-b88c-b2e10274fe54),

Urn(http://www.koretide.com/present invention/samples/hello.dll)

By this definition, the URN plays a role of unique identifying a component program, the component class in component program is identified by the class identifier.

For fast locating the component file, the class identification of COM standard is extended in present invention, and the class identification of present invention is introduced, it includes the global unique identifier (GUID) and also the URN of component program.

Because in COM's standard API and interface, all the parameters of class identification are transferred by form of citing or pointer, so the global unique identifier is prior to URN in present invention, this guarantees the compatibility to the standard COM. That is to say, the class identification in present invention could be utilized not only on the platform of present invention, but also on the platform of MSCOM.

Other than the URN, the description to component lead-in information includes also the component's edition number, class information edition number, last revised date, renewed period etc, it is utilized in component upgrade and fault recovery.

As FIG. 1 shows, the concrete generation of component lead-in information in present invention is:

The component lead-in information is generated by pre-handling component source program in present invention. When a component client utilizes a component, the component statement must be led-in through leading-in the pre-handling statement. For example:

The pre-handling of lead-in statement includes the following steps:

A Read in component source program.

B Fetch a statement to make syntax analysis and judge if the current statement is a lead-in, if no, go to C, if yes, go to D.

C Write the current statement in the temporary component source program and go to B.

D Upload the component DLL file specified by the lead-in statement, go to E if succeed, otherwise go to C.

E Upload the class information of component DLL file, go to F if succeed, otherwise go to C.

F Fetch the component's URN, edition, last revised date and renew period information from component class information, and add them to the lead-in information of current program;

G Generate the head file relative to the component definition according to the class information, modify the lead-in statement to a head file and write in the temporary component source program.

H Repeat A to G, till the syntax analysis of source program is ended.

I Write the lead-in information of current program in the lead-in information file.

After the pre-handling of component source program, 3 files are newly generated:

The temporary component source program file. The difference with the initial source program is that the lead-in statement is replaced with the head file. This is because of the component compiler couldn't handle correctly the lead-in statement, and the generated temporary source program is provided to the component compiler for real compiling;

The pre-handler generates a head file about the component definition for each lead-in statement of source program. The head file announces the class identification of component, URN and interface etc;

The lead-in information file of current program. The lead-in information file records the lead-in information records (URN, edition number, renew period etc) of all components utilized by the current program.

So the lead-in information of component is divided into two parts, one part is URN, in view of efficiency, the URN is announced directly in the generated component head file in form of class identification, each class identification is followed a URN characteristic string.

The second part of lead-in information is about the component edition, last revised date, class information edition and renew period etc. For the information not always be utilized, so they are written in a lead-in information file, and the lead-in information of all executable C/C++ source program is combined to a single one before linked. The lead-in information of program is linked to the resource section of DLL or EXE file as resource data in linking.

By the class identification with URN in present invention, the system could find and upload the correct component program according to URN in class identification automatically, and find out the corresponding component class according to the true class identification.

Through the URN mechanism, the component program could be utilized by component client terminal without installing and registering, because the URN is linked to the binary code of component client program in compiling, with the safety mechanism of digital signing etc, even the manager may not able to modify the component URN, and this effective prevents to virus and intruder program.

In present invention operation, in the component buffer storage based on component lead-in information, all the component programs are stored in the component buffer storage directory of network operation system, the component program in directory takes the URN as a unique identification (not file name).

Concretely, as FIG. 2 shows, the steps of component uploading according to URN by system are:

A the component client creates component object through specifying the class identification.

B system abstract the URN of component from the class identification.

C examine if component program existed by URN, and go to E if existed, otherwise go to D.

D abstract the lead-in information other than URN from component client resource section, download automatically the component program from network according to URN, edition number etc (the edition is no older than the edition number recorded in lead-in information). And go to E if succeed, otherwise return a failure.

E upload the component program and create the component object according to the class identification.

Moreover, the component self rolling operation and dynamic upstage methods based on component lead-in information in present invention are on basis of URN component lead-in information and component buffer storage mechanism, and the component or component client program in present invention may self rolling operate only if the basic component operation environment exists.

For example: suppose the component A relies on component B, and component B relies on C, and only the component A was installed in a certain system, in component A operation, when the component A creates the component object of component B, it specifies the URN of component B through class identification, and the system could download automatically the program of component B from network. In the same way, in condition of no installing of component C in prior, the component B could also operate correctly.

This self-rolling operation mechanism provides the software user for a good convenience, and the software user has no need to know at all any information other than the software he or she is utilizing. And the software developer has no need to make strenuously the installing software for big and complicated software.

In present invention, when component is uploaded for first time after system starting, the system would fetch the class information of component from resource section of component, and judge if the component needs to upgrade according to the component renew period in class information, in case of renew period begins, the system would download automatically the component renew edition from network according to the component URN.

While the present invention has been particularly shown and described with references to preferred embodiments thereof, it is clearly understood that the same is by way of illustration and example only and is not to be taken by way of limitation, it will be understood by those skilled in the art that various variations, alterations, and modifications in form and details may be made therein without departing from the spirit and scope of the invention as defined by the claims and it intended to be encompassed in the scope of the present invention.

We claim:

1. A component self-description package method, characterized in that: the class information of description component is packaged into component, the class information is from pre-compile file, the outside obtains the class information explanation directly from component and completes the self explanation through the standard function led out from component.

2. A component self-description package method according to claim 1, characterized in that: the class information includes the interface and method list describing the component lead-out.

3. A component self-description package method according to claim 2, characterized in that: the class information is packeted as a resource data into the resource section of component file.

4. A component self-description package method according to whichever of claim 3, characterized in that: the component source program generated automatically according to class information includes the realization code of standard lead-out function of component class object fetching, in the realization code, other than realizing the semanteme of standard component class object fetching, also supports to utilize a system pre-defining special class identification to obtain the class information of component.

5. A component self-description package method according to claim 4, characterized in that: when fetching the component class information by the component class object fetching function, the function returns the start address of component class information.

6. A component self-description package method according to claim 5, characterized in that: when system or component client needs to utilize the class information, the system pre-defining special class identification is used as a input parameter, and the class object fetching function of component is invoked for fetching.

7. A component self-description package method according to claim 4, characterized in that: when obtaining the component metadata, upload first the component module, then obtain the start address of component class object fetching function, and finally fetch the component class object fetching function to fetch the component class information.

8. A component dependent relation self-description package method, characterized in that: package the lead-in information description into component, the lead-in information description is from the pre-compile file, it includes the uniform resource name of other component used by the component and is for description the component dependent relation.

9. A component dependent relation self-description package method according to claim 8, characterized in that: the lead-in information description includes the other dependent component's edition number or class information edition number or revised date or renewed period, it is utilized in component upgrade or fault recovery.

10. A component dependent relation self-description package method according to claim 8, characterized in that: the lead-in statement of component source program is pre-handled by pre-handler and the lead-in information of component is generated.

11. A component dependent relation self-description package method according to whichever of claim 10, characterized in that: the operation steps of pre-handler are as bellow:
Step 1: read in compile source program first;
Step 2: fetch a statement to make syntax analysis and judge if is a lead-in, if yes, upload the component file specified by the statement, if yes, go to Step 4;
Step 3: write the current statement in the temporary source program and return back to Step 2;
Step 4: upload the class information of component file, return back to Step 3 if no succeed;
Step 5: fetch the component's uniform resource name and edition, last revised date and renew period information from class information of component resource section, and add them to the lead-in information of current program;
Step 6: generate the head file relative to the component definition according to the class information of lead-in component, modify the lead-in statement into a head file including—statement and write in the temporary source program.
Step 7: write the lead-in information of current program in the lead-in information file.

12. A component dependent relation self-description package method according to claim 11, characterized in that: repeat execute the steps above until the syntax analysis to source program is ended, in this way, the pre-handler generates a head file about the lead-in component definition for each lead-in statement of source program.

13. A component dependent relation self-description package method according to claim 12, characterized in that: the head file of component generated by pre-handler includes the class identification announcement of component, the class identification consists of the global unique identifier (GUID) and uniform resource name (URN), the uniform resource name of lead-in component is announced as a part of class identification together with class identification.

14. A component dependent relation self-description package method according to claim 11, characterized in that: the lead-in information file generated by the lead-in information pre-handler includes the complete description of component lead-in information, including the information of other used component's uniform resource name, last revised date and renew period etc, and they are packeted in the resource section of component file.

15. A operation method of self-description package component according to claim 1 above, characterized in that: the component client utilizes the specified component class identification in operation, the system finds out the component file according to the uniform resource name in class identification automatically and makes the uploading.

16. A operation method of self-description package component fulfilled on basis of claims above according to claim 15, characterized in that: after component file is installed, system finds out the relative component class according to the global unique identifier in class identification.

17. A operation method of self-description package component fulfilled on basis of claims above according to claim 15, characterized in that: the steps of uploading the component by system according to uniform resource name are as below:
Step 1: the component client creates component object through specifying the class identification;
Step 2: system abstract the uniform resource name of component from the class identification;
Step 3: examine with the uniform resource name that if component program existed, and go to Step 5 if existed;
Step 4: abstract the lead-in information other than uniform resource name from component client resource section, download automatically the component program from network according to uniform resource name, edition number, renew period information; and return back a failure if no succeed;
Step 5: upload the component program and create the component object according to the global unique identifier in class identification.

18. A operation method of self-description package component fulfilled on basis of claims above according to claim 17, characterized in that: a chain dependent relation between components is established by the uniform resource name in class identification, when a component utilizes another component through class identification, the system upload another component according to the uniform resource name in class identification and a self rolling operation is realized.

19. A operation method of self-description package component fulfilled on basis of claims above according to claim 17, characterized in that: when component is uploaded for first time after system starting, the system would fetch the class information of component from resource section of component, and judge if the component needs to upgrade according to the component renew period in class information, in case of renew period begins, the system would download automatically the component renew edition from network according to the uniform resource name of component, and realize the dynamic upgrade.
